(19) United States
(12) Patent Application Publication
(10) Pub. No.: US 2022/0159336 A1
(43) Pub. Date: May 19, 2022

(54) METHOD AND SYSTEM FOR DISPLAYING SCREEN

(71) Applicant: BEIJING DAJIA INTERNET INFORMATION TECHNOLOGY CO., LTD., Beijing (CN)

(72) Inventor: Xiao TANG, Beijing (CN)

(21) Appl. No.: 17/487,297

(22) Filed: Sep. 28, 2021

(30) Foreign Application Priority Data
Nov. 16, 2020 (CN) 202011281516.X

(51) Int. Cl. H04N 21/4402; G09G 5/14; H04N 21/478; H04N 21/81; A63F 13/52

(52) U.S. Cl. CPC H04N 21/4402; G09G 5/14; G09G 2354/00; H04N 21/8173; A63F 13/52; H04N 21/4781

(57) ABSTRACT

A method for displaying a screen is provided. In the method, a first client displays a first screen corresponding to a first video stream, and the first screen is also displayed on a second client associated with the first client; the first client acquires an operation instruction for the first screen, and sends the operation instruction to a first server; the first server sends the operation instruction to a second server, receives a first target video stream from the second server, and sends the first target video stream to the first client and the second client, and the second server is configured to acquire the first target video stream in response to the operation instruction; and the first client receives the first target video stream and displays a first target screen, and the first target screen is also displayed on the second client.

### CROSS REFERENCE TO RELATED APPLICATION

This disclosure is based on and claims priority to Chinese Patent Application No. 202011281516.X, filed on Nov. 16, 2020, the disclosure of which is herein incorporated by reference in its entirety.

### TECHNICAL FIELD

The present disclosure relates to the field of Internet technologies, and in particular, relates to a method and system for displaying a screen.

### BACKGROUND

In the related art, games are run by a cloud server. Usually, the cloud server sends a game video stream, and a terminal receives the game video stream and displays the game video stream, and returns an operation instruction for the game video stream to the cloud server.

### SUMMARY

According to a first aspect of embodiments of the present disclosure, a method for displaying a screen is provided. The method is executed by a first client, and includes:

displaying a first screen corresponding to a first video stream, wherein the first screen is also displayed on a second client associated with the first client;

acquiring an operation instruction for the first screen, and sending the operation instruction to a first server, wherein the first server is configured to send the operation instruction to a second server, receive a first target video stream from the second server, and send the first target video stream to the first client and the second client, and the second server is configured to acquire the first target video stream in response to the operation instruction; and

receiving the first target video stream from the first server, and displaying a first target screen corresponding to the first target video stream on the first client, wherein the first target screen is also displayed on the second client.

According to another aspect of the embodiments of the present disclosure, a method for displaying a screen is provided. The method is applicable to a first server, and includes:

receiving a first video stream from a second server, and sending the first video stream to a first client and a second client, wherein the second client is associated with the first client;

receiving an operation instruction for a first screen from a first client, and sending the operation instruction to the second server, wherein the first screen is corresponding to the first video stream, and the second server is configured to acquire a first target video stream by updating the first video stream in response to the operation instruction; and

receiving the first target video stream from the second server, and sending the first target, video stream to the first client and the second client.

According to yet another aspect of the embodiments of the present disclosure, an electronic device is provided. The electronic device includes a processor and a memory configured to store one or more instructions executable by the processor; wherein the processor, when loading and executing the one or more instructions, is caused to perform:

displaying a first screen corresponding to a first video stream on a first client, wherein the first screen is also displayed on a second client associated with the first client;

acquiring an operation instruction for the first screen, and sending the operation instruction to a first server, wherein the first server is configured to send the operation instruction to a second server, receive a first target video stream from the second server, and send the first target video stream to the first client and the second client, and the second server is configured to acquire the first target video stream in response to the operation instruction; and

receiving the first target video stream from the first server, and displaying a first target screen corresponding to the first target video stream on the first client, wherein the first target screen is also displayed on the second client.

### BRIEF DESCRIPTION OF THE DRAWINGS

FIG. 1 is a schematic diagram of an application environment of a method for displaying a screen according to an exemplary embodiment of the present disclosure;

FIG. 2 is a flowchart of a method for displaying a screen according to an exemplary embodiment of the present disclosure;

FIG. 3 is a schematic diagram of an interface for displaying an operation request according to an exemplary embodiment of the present disclosure;

FIG. 4 is a flowchart of switching a screen according to an exemplary embodiment of the present disclosure;

FIG. 5 is a schematic diagram of an interface for displaying a first screen and a second screen according to an exemplary embodiment of the present disclosure;

FIG. 6 is a flowchart of a method for displaying a screen according to another exemplary embodiment of the present disclosure;

FIG. 7 is a flowchart of sending a video stream according to an exemplary embodiment of the present disclosure;

FIG. 8 is an interaction flowchart of a method for displaying a screen according to an exemplary embodiment of the present disclosure;

FIG. 9 is an interaction flowchart of a method for displaying a screen according to another exemplary embodiment of the present disclosure;

FIG. 10 is a block diagram of an apparatus for displaying a screen according to an exemplary embodiment of the present disclosure;

FIG. 11 is a block diagram of an apparatus for displaying a screen according to another exemplary embodiment of the present disclosure;

FIG. 12 is a block diagram of a system for displaying a screen according to an exemplary embodiment of the present disclosure;

FIG. 13 is a schematic diagram of an internal structure of an electronic device according to an exemplary embodiment of the present disclosure; and

FIG. 14 is a schematic diagram of an internal structure of a server according to an exemplary embodiment of the present disclosure.

### DETAILED DESCRIPTION

It should be noted that terms “first,” and “second,” and the like in the description and claims as well as the above drawings in the present disclosure are merely intended to distinguish similar objects rather than intended to describe a specific order or a sequence. It should be understood that data thus used are interchangeable in an appropriate circumstance, such that the embodiments of the present disclosure described herein may be implemented in an order other than those illustrated or described herein.

In the related art, if a terminal needs to share a game video stream to other terminals, the terminal typically pushes the game video stream to the other terminals while sending an operation instruction to a cloud server. Therefore, power consumption of the terminal is excessively high for such simultaneous operations.

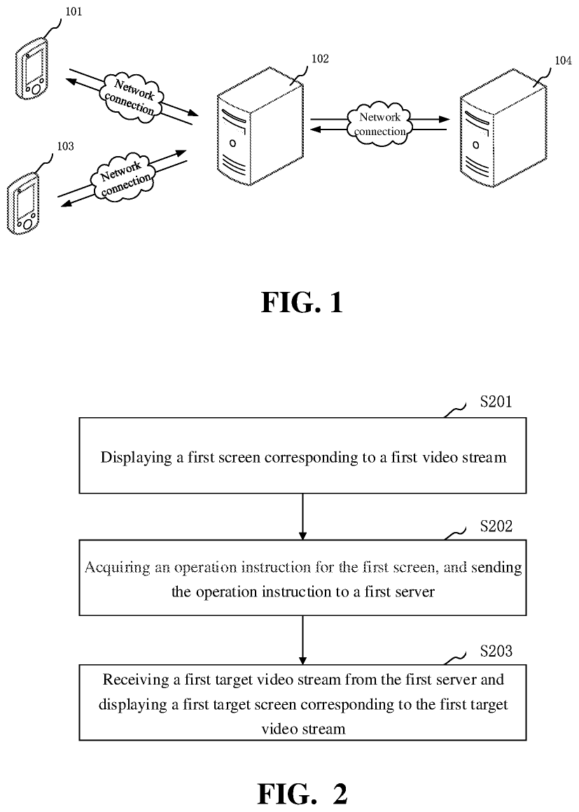

A method for displaying a screen according to an embodiment of the present disclosure may be applicable to an application environment as shown in FIG. 1. A first client 101 and a second client 103 interact with a first server 102 over a network, and the first server 102 interacts with a second server 104. In some embodiments, the second server 104 may be a cloud game server where a game is installed, and the first server 102 may acquire a game video stream from the second server 104 and send the game video stream to the first client 101 and the second client 103 which are communicatively connected to the first server 102; the first client 101 and the second client 103 may display a game screen corresponding to the game video stream; the first client 101 or the second client 103 may acquire a game operation instruction for the game screen and return the game operation instruction to the first server 102; the first server 102 may send the game instruction to the second server 104; the second server 104 may update the game video stream based on the game operation instruction and send an updated target game video stream to the first server 102; the first server 102 may return the target game video stream to the first client 101 and the second client 103; and the first client 101 and the second client may display a game screen corresponding to the target game video stream. It should be noted that the process of displaying the game screen corresponding to the game video stream is explained by taking a game scenario as an example. In addition, the method for displaying the screen according to embodiments of the present disclosure may also be applicable to other scenarios, such as displaying a multimedia screen corresponding to a multimedia video stream in the scenario of watching multimedia data. The first client 101 and the second client 103 may include, but are not limited to, various personal computers, laptops, smartphones, tablet computers, and portable wearable devices, and the first server 102 and the second server 104 may be implemented by independent servers or a server cluster composed of a plurality of servers. The first client 101 is associated with the second client 103. For example, in a live-streaming scenario, the first client 101 is an anchor client and the second client 103 is an audience client associated with the anchor client. The first client 101 and the second client 103 may run on various electronic devices, which are, for example, terminals such as personal computers, laptops, smartphones, tablet computers, or portable wearable devices.

FIG. 2 is a flowchart of a method for displaying a screen according to an exemplary embodiment. As shown in FIG. 2, the method for displaying the screen is executed by a first client, and includes the following processes.

In S201, the first client 101 displays a first screen corresponding to a first video stream, wherein the first screen is also displayed on a second client 103 associated with the first client 101.

The first client 101 and the second client 103 share the first video stream, i.e., both the first client 101 and the second client 103 display the first screen corresponding to the first video stream. The first video stream may be any type of video stream, e.g., a game video stream or a multimedia video stream, and the first screen corresponding to the game video stream is a game screen.

The first client 101 is associated with the second client 103. That is, the first client 101 and the second client 103 may display a screen corresponding to the same video stream. The first client 101 may be associated with one second client 103 or a plurality of different second clients 103. In some embodiments, the second client 103 and the first client 101 are disposed in the same virtual space, and for example, the second client 103 and the first client 101 that are disposed in the same live-streaming room or in the same online meeting room may synchronously display the first screen corresponding to the first video stream.

In an exemplary embodiment, the first client 101 receives the first video stream from the first server 102, wherein the first video stream is acquired by the first server 102 from the second server 104, and the first server is further configured to send the first video stream to the second client 103.

The first video stream is acquired from the second server 104 that is configured to provide services for the first client 101. The first server 102 is a server that exchanges information with the first client 101 and the second server 104 separately. The first client 101 does not communicate with the second server 104 directly, but communicate with the first server 102. In a game scenario, the second server is a game server, the first video stream is a game video stream corresponding to a game installed in the second server 104, the first client 101 is a client for feeding back a game operation instruction to a game screen, and the first client 101 and the second client 103 acquire the game video stream for displaying the game screen from the second server 104 by the first server 102 and display the game screen corresponding to the acquired game video stream.

In S202, the first client 101 acquires an operation instruction for the first screen, and sends the operation instruction to the first server 102.

The first server 102 is configured to send the operation instruction to the second server 104, receive a first target video stream from the second server 104, and send the first target video stream to the first client 101 and the second client 103. The first target video stream is acquired by the second server 104 in response to the operation instruction. The second client 103 is configured to display a first target screen corresponding to the first target video stream. In a game scenario, the operation instruction for the first screen is a game operation instruction in response to the first screen being a game scenario.

The first target video stream is a video stream acquired by the second server 104 according to the operation instruction. In some embodiments, after displaying the first screen, the first client may acquire the operation instruction based on the displayed first screen. For example, the operation instruction may be acquired by the first client 101 in response to a user performing a triggering operation on the first screen, or may be generated by the first client 101 according to a preset program. The first client 101 may send the operation instruction to the first server 102 over a network, such that the first server 102 may send the operation instruction to the second server 104, and then the second server 104 may acquire the first target video stream according to the operation instruction, communicate with the first server 102, and then the first server 102 may return the first target video stream to the first client 101 and the second client 103.

In S203, the first client 101 receives the first target video stream from the first server 102, and displays a first target screen corresponding to the first target video stream.

The first server 102 returns the first target video stream to the first client 101, and the first client 101 can receive the first target video stream and display the first target screen corresponding to the first target video stream, i.e., the first target screen acquired in response to operating the first screen corresponding to the first video stream, i.e., the updated first screen.

The first target screen and the first screen belong to the same type of screens, and their difference lies in that the first screen is generated by the first video stream, the first target screen is generated by the first target video stream, and the contents of the first target screen and the first screen are different because the video streams are changed.

In the above method for displaying the screen, both the first client 101 and the second client 103 can display the first screen corresponding to the first video stream. In response to detecting the operation instruction for the first screen, the first client 101 may send the operation instruction to the second server 104 via the first server 102, such that the second server 104 may acquire the first target video stream and may enable the first server 102 acquire the first target video stream corresponding to the operation instruction from the first client 101. The first target video stream may be sent to the first client 101 and the second client 103, such that both the first client 101 and the second client 103 may display the first target screen corresponding to the first target video stream, which enables the first client 101 and the second client 103 to update the first screen synchronously. Therefore, the first client 101 does not need to push the video stream to the second client 103, reducing the power consumption of the electronic device where the first client 101 is disposed.

In an exemplary embodiment, the screen displaying method further comprises: in response to a first switching instruction, the first client 101 sends the first switching instruction to the first server, wherein the first switching instruction indicates that an operation authority is switched to a second target client. The first server 102 responds to the operation instruction from the second target client, based on the first switching instruction.

There may be a plurality of second clients 103 which include a second target client, and the second target client is one of the second clients 103 that can send the operation instruction. The first client 101 can transfer the operation authority to the second target client, and the second target client can send the operation instruction based on the first screen corresponding to the first video stream. In some embodiments, the first client 101 may acquire the first switching instruction, for example, the first switching instruction may be generated by triggering of the user of the first client 101, and is configured to switch the game operation authority. In response to the first switching instruction, the first client 101 may send the first switching instruction to the first server 102. Based on the acquired first switching instruction, the first server 102 may respond to the operation instruction from the second target client and stop responding to the operation instruction from the first client 101. In some embodiments, the first client 101 may stop sending the operation instruction for the first screen to the first server 102 in response to the first switching instruction.

In some embodiments, the first client 101 receives an operation request from the second target client and displays the operation request, and in response to a confirmation instruction for the operation request, determines the confirmation instruction as the first switching instruction.

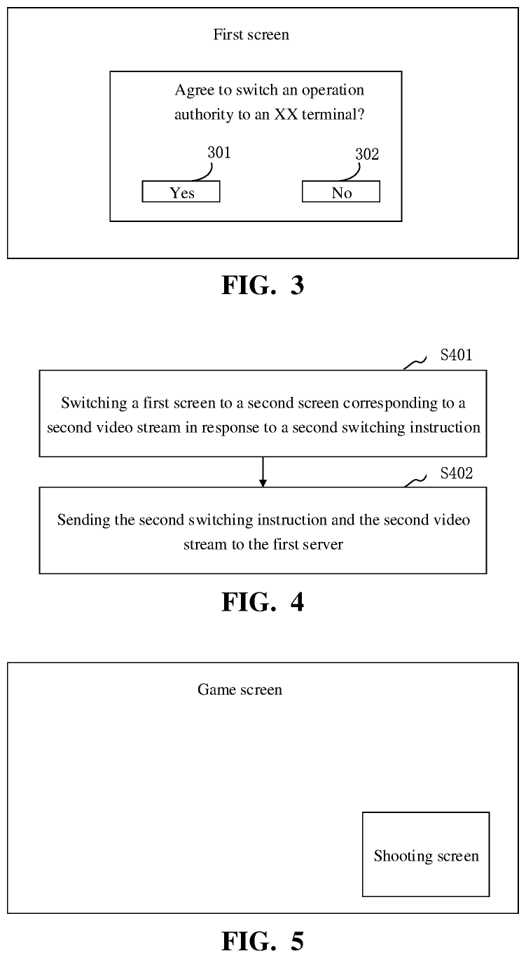

The operation request is configured to request switching the operation authority to the second target client. For example, the operation request is generated by a triggering operation by a user of the second target client. The operation request from the second target client may be displayed on an interface of the first client 101 in the form of a pop-up window. As shown in FIG. 3, on an exemplary first screen of the first client 101, in response to receiving the operation request from the second target client, the first client 101 may display the operation request on the first screen in the form of a pop-up window, and the user of the first client 101 may trigger an operation instruction for the operation request by clicking a button on the pop-up window. In response to detecting the confirmation instruction, the first client 101 may determine the confirmation instruction as the first switching instruction, and send the first switching instruction to the first server 102. As shown in FIG. 3, the pop-up window includes a confirmation button 301 and a rejection button 302. The first client 101 may determine that the confirmation instruction is detected in response to a triggering operation on the confirmation button 301. The first client 101 may determine that an operation rejection instruction is detected in response to a triggering operation on the rejection button 302, and thus refuse to switch the operation authority to the second target client.

In the above embodiment, the first client 101 may switch the operation authority to the second target client, and the second target client may request, by sending the operation request, the first client 101 to transfer the operation authority, such that an interaction between the first client 101 and the second client 103 is realized. In the case that the first client 101 is incapable of acquiring the operation instruction, a normal display of the first screen may be ensured by switching the operation authority, thereby improving the display fluency of the screen.

In an exemplary embodiment, the first server 101 is a live-streaming server, the first client 101 and the second client 103 are disposed in the same virtual space, and the first client 101 is an anchor client. In an exemplary embodiment, the second server 104 is a game server and the second client 103 is an audience client.

In an exemplary embodiment, as shown in FIG. 4, the method for displaying the screen further includes the following processes.

In S401, the first client 101 switches the first screen to a second screen corresponding to a second video stream in response to a second switching instruction. The second switching instruction indicates screen switching, and the second video stream is acquired by the electronic device where the first client 101 is disposed. For example, the electronic device where the first client 101 is disposed is an image acquisition device.

The second switching instruction is configured to switch the first screen displayed by the first client 101 to a screen acquired by the electronic device, for example, the second switching instruction may be generated by triggering of the user of the first client 101. In response to the second switching instruction, the electronic device may acquire the second video stream, e.g., by a camera in the electronic device, and may switch the first screen displayed by the first client 101 to the second screen corresponding to the second video stream. For example, in the game live-streaming scenario, the first server 102 is a live-streaming server for live-streaming, the first client 101 and the second client 103 are disposed in the same virtual space, e.g., in the same live-streaming room, the first client 101 is an anchor client, the first screen is a game screen, and the second screen corresponding to the second video stream is a shooting screen of the electronic device. The electronic device may switch the game screen displayed on the first client 101 to the shooting screen of the electronic device in response to the second switching instruction.

The second screen and the first screen are different types of screens. Since the first screen is generated by the first video stream and the second screen is generated by the second video stream, and the first video stream and the second video stream belong to different types of video streams, for example, the first video stream is a game video stream and the second video stream is a video stream shot by the electronic device, the first screen and the second screen are also of different types.

In S402, the first client 101 sends the second switching instruction and the second video stream to the first server 102, wherein the first server 102 is configured to send the second video stream to the second client 103, and stop sending the first video stream to the first client 101 and the second client 103 in response to the second switching instruction.

In response to receiving the second switching instruction, the first client 101 may also send the second switching instruction and the captured second video stream to the first server 102, such that the first server 102 may send the second video stream to the second client 103 (e.g., the audience client in the live-streaming room) based on the second switching instruction, and at the same time, stop sending the first video stream to the first client 101 and the second client 103. The second client may switch the first screen corresponding to the first video stream to the second screen corresponding to the second video stream based on the acquired second video stream.

In the above embodiment, the first client 101 may switch the first screen displayed by the first client 101 and the second client 103 to the second screen based on the second switching instruction, thereby realizing seamless switching between the first screen and the second screen. For example, during live-streaming of the game, seamless switching between the game screen and the shooting screen is realized.

In addition, in some embodiments, the first client 101 may display the second screen corresponding to the second video stream in the form of a floating window in the first screen in response to a third switching instruction, wherein the third switching instruction indicates that the first screen and the second screen are displayed simultaneously, and the second video stream is captured by the electronic device where the first client 101 is disposed.

As shown in FIG. 5, on an exemplary interface of the first client 101, by taking a game live-streaming scenario as an example, the first screen is a game screen and the second screen is a shooting screen. During carrying out the game live-streaming as the live-streaming client, the first client 101 may also display the shooting screen acquired by the image acquisition device corresponding to the first client 101 in the form of a floating window. That is, the game screen and the shooting screen are displayed simultaneously. In response to receiving the third switching instruction, the first client 101 may acquire the first video stream from the first server 102 and the second video stream from the image acquisition device simultaneously, such that the first client 101 may display the shooting screen corresponding to the second video stream in the game screen corresponding to the first video stream in the form of a floating window.

In embodiments of the present disclosure, while displaying the game screen, the first client 101 may display the shooting screen in the form of a floating window, which helps to improve the interestingness of the game live-streaming process.

In an exemplary embodiment, the first client 101 may further stop displaying the first screen, and switch the second screen from being displayed in the form of a floating window to being displayed in the form of a full screen in response to a second switching instruction, wherein the second switching instruction indicates screen switching.

In the case that the first client 101 displays the first screen and the second screen simultaneously, the first client 101 displays the second screen in the form of a floating window. In response to detecting the second switching instruction that indicates screen switching, the first client 101 stops displaying the first screen corresponding to the first video stream and switches the second screen from being displayed in the form of a floating window to being displayed in the form of a full screen.

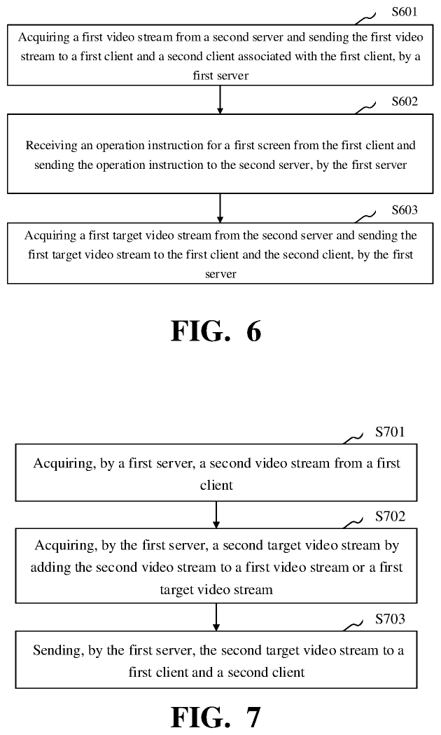

FIG. 6 is a flowchart of a method for displaying a screen according to an exemplary embodiment of the present disclosure. As shown in FIG. 6, the method is applicable to a first server 102, and includes the following processes.

In S601, the first server 102 acquires a first video stream from a second server 104, and sends the first video stream to a first client 101 and a second client 103 associated with the first client 101.

The first server 102 acquires the first video stream from the second server 104 and sends the acquired first video stream to the first client 101 and the second client 103, such that the first client 101 and the second client 103 display a first screen corresponding to the first video stream. In a game scenario, the second server 104 is a game server, and the first server 102 acquires a game video stream corresponding to a game screen from the second server 104 where a game is installed.

In S602, the first server 102 receives an operation instruction for the first screen from the first client 101, and sends the operation instruction to the second server 104. The first screen is a screen corresponding to the first video stream, and the second server 104 is configured to acquire an updated first target video stream by updating the first video stream in response to the operation instruction.

After sending the first video stream to the first client 101, the first server 102 may receive the operation instruction for the first screen from the first client 101 and send the operation instruction to the second server 104, and the second server 104 may acquire the updated first target video stream by updating the first video stream based on the operation instruction.

In S603, the first server 102 acquires the first target video stream from the second server 104 and sends the first target video stream to the first client 101 and the second client 103.

The first server 102 acquires the updated first target video stream from the second server 104, and sends the first target video stream to the first client 101 and the second client 103, such that the first client 101 and the second client 103 may display the first target screen corresponding to the first target video stream, i.e., update the first screen corresponding to the first video stream to a screen corresponding to the target video stream.

In the above method for displaying the screen, both the first client 101 and the second client 103 may display the first screen corresponding to the first video stream. In response to detecting the operation instruction for the first screen, the first client 101 sends the operation instruction to the second server 104 via the first server 102, such that the first server 102 may acquire the first target video stream corresponding to the operation instruction from the second server 104. The first target video stream is sent to the first client 101 and the second client 103, such that both the first client 101 and the second client 103 may display the first target screen corresponding to the first target video stream, which enables the first client 101 and the second client 103 to update the first screen synchronously. Therefore, the first client 101 does not need to push the video stream to the second client 103, reducing the power consumption of the electronic device where the first client 101 is disposed.

In an exemplary embodiment, the first server 102 may receive a first switching instruction from the first client 101, wherein the first switching instruction indicates that an operation authority is switched to a second target client. Based on the first switching instruction, the first server 102 responds to an operation instruction from the second target client.

The first client 101 may transfer the operation authority to the second target client, and the second target client may send the operation instruction based on the first screen corresponding to the first video stream. The first client 101 sends the first switching instruction to the first server 102. The first server 102 may respond to the operation instruction for the first screen corresponding to the first video stream from the second target client in response to receiving the first switching instruction, and stop responding to the operation instruction from the first client 101, thereby completing the switching of the operation authority. In some embodiments, the first client 101 may send the first switching instruction to the first server 102, and stop sending the operation instruction for the first screen to the first server 102 in response to the first switching instruction, such that the first server 102 will no longer receive the operation instruction from the first client 101, and thus, will not need to respond to the operation instruction from the first client 101.

In the above embodiment, the first client 101 may switch the operation authority to the second target client. In the case that the first client 101 is incapable of capturing the game operation instruction, the normal display of the first screen may be ensured by switching the operation authority, thereby improving the display fluency of the screen.

In an exemplary embodiment, the first server 102 is a live-streaming server, the first client 101 and the second client 103 are disposed in the same virtual space, and the first client 101 is an anchor client. In an exemplary embodiment, the second server 104 is a game server and the second client 103 is an audience client.

In an exemplary embodiment, the first server 102 may receive a second switching instruction and a second video stream from the first client 101, wherein the second video stream is captured by the electronic device where the first client 101 is disposed. The first server 102 may send the second video stream to the second client 103, and stop sending the first video stream to the first client 101 and the second client 103. For example, the electronic device where the first client 101 is disposed is an image acquisition device.

The second switching instruction is configured to switch the first screen displayed by the first client 101 to a screen captured by the electronic device. For example, the second switching instruction is generated by triggering of the user of the first client 101. For example, in a game live-streaming scenario, the first server 102 is a live-streaming server, the first client 101 and the second client 103 correspond to the same live-streaming room, the first client 101 is an anchor client of an anchor and the second client 103 is an audience client of the audience. The first screen is a game screen, the second screen corresponding to the second video stream is a shooting screen of the electronic device, and the second switching instruction is configured to switch the game screen to the shooting screen. In response to receiving the second switching instruction from the first client 101, the first server 102 acquires the second video stream from the first client 101, sends the second video stream to the second client 103, and stops sending the first video stream to the first client 101 and the second client 103, such that the second client 103 switches the displayed game screen to the shooting screen corresponding to the first video stream.

In an exemplary embodiment, as shown in FIG. 7, the first server 102 sends the first video stream or the first target video stream to the first client 101 and the second client 103, and the method further includes the following processes.

In S701, the first server 102 acquires the second video stream from the first client 101.

The second video stream is captured by the electronic device where the first client 101 is disposed, and the first client 101 sends the second video stream to the first server 102.

In S702, the first server 102 acquires a second target video stream by adding the second video stream to the first video stream or the first target video stream. In a second target screen corresponding to the second target video stream, a second screen corresponding to the second video stream is displayed in the first screen of the first video stream or the first target video stream in the form of a floating window.

In S703, the first server 102 sends the second target video stream to the first client 101 and the second client 103.

The second target video stream is acquired by the first server 102 by processing the first video stream or the first target video stream acquired from the second server 104 and the second video stream acquired from the first client 101. In some embodiments, the first server 102 may form the second target video stream by adding the second video stream into the first video stream or the first target video stream, and send the second target video stream to the first client 101 and the second client 103, such that the first client 101 and the second client 103 may display the second screen corresponding to the second video stream in the first screen in the form of a floating window based on the second target video stream. For example, in a game live-streaming scenario, the first screen is a game screen, the second screen corresponding to the second video stream is a shooting screen of the electronic device.

That is, the first server 102 acquires the second video stream from the first client 101 and sends the second video stream to the second client 103. The second screen corresponding to the second video stream is configured to be displayed on the first screen in the form of a floating window, and the second video stream is captured by the electronic device where the first client is disposed. Therefore, in response to receiving the second video stream, the second client 103 displays the second screen corresponding to the second video stream in the first screen in the form of a floating window.

In addition, the first server 102 may send the second video stream to the second client 103 and stop sending the first video stream to the first client 101 and the second client 103 in response to the second switching instruction from the first client 101. The second screen corresponding to the second video stream is switched from being displayed in the form of a floating window to being displayed in the form of a full screen.

In the case that the second client 103 displays the second screen corresponding to the second video stream in the form of a floating window, in response to receiving the second switching instruction from the first client 101, the first server 102 directly sends the second video stream to the second client 103, and at the same time, stops sending the first video stream to the first client 101 and the second client 103. Meanwhile, the second client 103 switches the second screen from being displayed in the form of a floating window to being displayed in the form of a full screen in response to acquiring the second video stream.

In the above embodiment, the first server 102 may switch the first screen displayed on the first client 101 and the second client 103 to the second screen based on the received second switching instruction. Meanwhile, in the process of sending the first video stream or the target video stream to the first client 101 and the second client 103, the first video stream or the target video stream may be processed by using the second video stream, such that the first client 101 and the second client 103 may display the second screen in the displayed first screen in the form of a floating window. In addition, the second screen may be switched from being displayed in the form of a floating window to being displayed in the form of a full screen based on the second switching instruction, thereby improving the switching consistency of the screen.

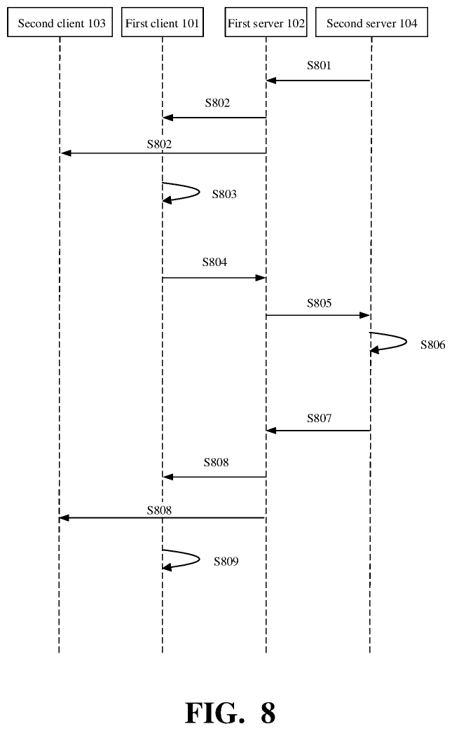

FIG. 8 is a flowchart of a method for displaying a screen according to an exemplary embodiment of the present disclosure. As shown in FIG. 8, the method is applicable to the application environment as shown in FIG. 1, and includes the following processes.

In S801, a second server 104 acquires a first video stream corresponding to a first screen and sends the first video stream to a first server 102.

In S802, the first server 102 receives the first video stream from the second server 104 and sends the first video stream to the first client 101 and the second client 103.

In S803, the first client 101 receives the first video stream from the first server and displays a first screen corresponding to the first video stream.

In S804, the first client 101 acquires an operation instruction for the first screen, and sends the operation instruction to the first server 102.

In S805, the first server 102 receives the operation instruction from the first client 101, and sends the operation instruction to the second server 104.

In S806, the second server 104 acquires a first target video stream (i.e., the updated first target video stream) by updating the first video stream in response to the operation instruction from the first server 102.

In S807, the second server 104 sends the first target video stream to the first server 102.

In S808, the first server 102 receives the first target video stream from the second server 104 and sends the first target video stream to the first client 101 and the second client. 103.

In S809, the first client 101 receives the first target video stream from the first server 102 and displays a first target screen corresponding to the first target video stream.

In the IG the screen, the first server 102 may push the first video stream acquired from the second server 104 to the second client 103 without requirement of simultaneously connecting two servers to the first client 101, thereby reducing the power consumption of an electronic device where the first client 101 is disposed.

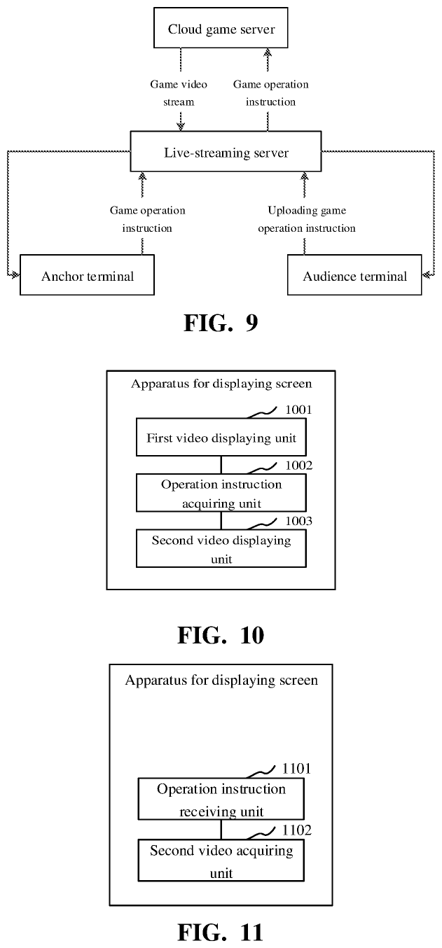

FIG. 9 is a flowchart of a method for displaying a screen according to an exemplary embodiment of the present disclosure. As shown in FIG. 9, the method may be applicable to a method for cloud game live-streaming based on a cloud game live-streaming system. The cloud game live-streaming system includes a cloud game server, a live-streaming server, an anchor terminal and an audience terminal. The method includes the following processes.

As a direct cloud game client, the live-streaming server receives a game video stream of the cloud game server, and sends a game operation instruction to the cloud game server.

The live-streaming server pushes the game video stream to the anchor terminal, and the anchor terminal sends a game operation instruction of a player to the live-streaming server.

The anchor terminal also supports pushing a local video stream, and in response to the anchor client pushing the local video stream, the live-streaming server switches the game video stream pushed to the audience terminal to the local video stream.

By using the above method for cloud game live-streaming, an anchor and the audience may interact with each other in a game in a game live-streaming room, and the anchor terminal may avoid excessively high power consumption caused by not only playing the game but also pushing the video stream. Meanwhile, the anchor may further switch screens corresponding to the game video stream and the local video stream at any time during the game live-streaming. Further, the anchor may transfer the operation authority of the game to the audience in the live-streaming room. In response to the audience taking over the game, the audience terminal captures the game operation instruction and uploads the captured game operation instruction to the live-streaming server. In addition, the audience may apply for playing a game for the anchor. In response to a successful application, the audience may take over the game, and the anchor may take a short break to prevent awkward silence of the live-streaming in response to the anchor being temporarily absent.

It should be understood that although various processes in the flowcharts of FIG. 2 to FIG. 9 are sequentially shown as indicated by arrows, these processes are unnecessarily performed in the order indicated by the arrows. Unless clearly described herein, there is no strict sequential limitation on the performance of these processes, and these processes may be performed in other orders.

FIG. 10 is a block diagram of an apparatus for displaying a screen according to an exemplary embodiment of the present disclosure. As shown in FIG. 10, the apparatus is applicable to an electronic device, and includes a first video displaying unit 1001, an operation instruction acquiring unit 1002 and a second video displaying unit 1003.

The first video displaying unit 1001 is configured to display a first screen corresponding to a first video stream on a first client, wherein the first screen is also displayed on a second client associated with the first client.

The operation instruction acquiring unit 1002 is configured to acquire an operation instruction for the first screen, and send the operation instruction to a first server, wherein the first server is configured to send the operation instruction to a second server, receive a first target video stream from the second server, and send the first target video stream to the first client and the second client, and the second server is configured to acquire the first target video stream in response to the operation instruction.

The second video displaying unit 1003 is configured to receive the first target video stream from the first server, and display a first target screen corresponding to the first target video stream on the first client, wherein the first target screen is also displayed on the second client.

In an exemplary embodiment, the apparatus further includes a video receiving unit, configured to receive a first video stream from the first server, wherein the first video stream is acquired by the first server from the second server, and the first server is further configured to send the first video stream to the second client.

In an exemplary embodiment, the apparatus further includes a first switching responding unit, configured to send a first switching instruction to the first server, wherein the first switching instruction is configured to indicate that an operation authority is switched to a second target client, associated with the first client and the first server is configured to respond to an operation instruction from the second target client based on the first switching instruction.

In an exemplary embodiment, the apparatus further includes an instruction determining unit, configured to receive an operation request from the second target client, and display the operation request on the first client, and determine, in response to a confirmation instruction for the operation request, the confirmation instruction as the first switching instruction.

In an exemplary embodiment, the apparatus further includes a second switching responding unit, configured to switch the first screen displayed by the first client to a second screen corresponding to a second video stream in response to a second switching instruction, wherein the second switching instruction is configured to indicate screen switching, and the second video stream is captured by an electronic device where the first client is disposed; and send the second switching instruction and the second video stream to the first server, wherein the first server is configured to send the second video stream to the second client and stop sending the first video stream to the first client and the second client in response to the second switching instruction.

In an exemplary embodiment, the apparatus further includes a third switching responding unit, configured to display a second screen corresponding to a second video stream in the form of a floating window in the first screen in response to a third switching instruction, wherein the third switching instruction is configured to indicate that the first screen and the second screen are to be displayed simultaneously, and the second video stream is captured by an electronic device where the first client is disposed.

In an exemplary embodiment, the apparatus further includes a second switching responding unit configured to stop displaying the first screen, and switch the second screen from being displayed in the form of a floating window to being displayed in the form of a full screen in response to a second switching instruction, wherein the second switching instruction is configured to indicate screen switching.

FIG. 11 is a block diagram of an apparatus for displaying a screen according to an exemplary embodiment of the present disclosure. As shown in FIG. 11, the apparatus is applicable to a first server, and includes an operation instruction receiving unit 1101 and a second video acquiring unit 1102.

The operation instruction receiving unit 1101 is configured to receive an operation instruction for a first screen from a first client, and send the operation instruction to a second server, wherein the first screen is a screen corresponding to a first video stream, and the second server is configured to acquire an updated first target video stream by updating the first video stream in response to the operation instruction.

The second video obtaining unit 1102 is configured to acquire the first target video stream from the second server, and send the first target video stream to the first client and a second client associated with the first client, wherein the first client and the second client are configured to display a first target screen corresponding to the first target video stream.

In an exemplary embodiment, the apparatus further includes a first video acquiring unit configured to acquire the first video stream from the second server, and send the first video stream to the first client and the second client, wherein the first client and the second client are configured to display the first screen corresponding to the first video stream.

In an exemplary embodiment, the apparatus further includes a first switching receiving unit, configured to display, in response to an operation request from the second target. client, the operation request on the first client, and determine, in response to a confirmation request for the operation request, the confirmation instruction as a first switching instruction.

In an exemplary embodiment, the apparatus further includes a second switching receiving unit, configured to: receive a second switching instruction and a second video stream from the first client, wherein the second switching instruction indicates screen switching, and the second video stream is captured by an electronic device where the first client is disposed; and send the second video stream to the second client; and stop sending the first video stream to the first client and the second client.

In an exemplary embodiment, the apparatus further includes a second switching receiving unit, configured to: acquire a second video stream from the first client, wherein a second screen corresponding to the second video stream is configured to be displayed on the first screen in the form of a floating window, and the second video stream is captured by an electronic device where the first client is disposed; and send the second video stream to the second client.

In an exemplary embodiment, the second switching receiving unit is further configured to send a live-steaming video stream to the second client, and stop sending a current video stream or the target video stream to the first client and the second client in response to receiving a second switching instruction from the first client for switching a live-streaming screen. The live-streaming screen corresponding to the live-streaming video stream is switched from being displayed in the form of a floating window to being displayed in a form of a full screen.

Specific fashions in which various modules of the apparatus in the above embodiment perform operations are already described in detail in the method embodiments, and thus are not described in detail herein.

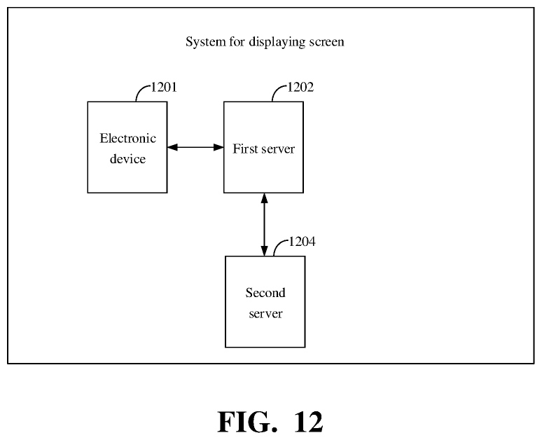

FIG. 12 is a block diagram of a system for displaying a screen according to an exemplary embodiment of the present disclosure. As shown in FIG. 12, the system includes a first server 1202, as well as a second server 1204 and an electronic device 1201 that are communicatively connected to the first server 1202.

The electronic device 1201 is configured to display a first screen corresponding to a first video stream on a first client, wherein the first screen is configured to be displayed on a second client associated with the first client.

The electronic device 1201 is configured to send, in response to an operation instruction for the first screen, the operation instruction to the first server 1202.

The first server 1202 is configured to send the operation instruction to the second server 1204.

The second server 1204 is configured to acquire an updated first target video stream by updating the first video stream in response to the operation instruction and send the first target video stream to the first server 1202.

The first server 1202 is configured to acquire the first target video stream from the second server 1204, and send the first target video stream to the first client and a second client, wherein the second client is configured to display a first target screen corresponding to the first target video stream.

The electronic device 1201 is configured to receive the first target video stream from the first server 1202, and display the first target screen corresponding to the first target video stream on the first client.

In an exemplary embodiment, the second server 1204 is further configured to send the first video stream to the first server 1202; the first server 1202 is further configured to acquire the first, video stream from the second server 1204, and send the first video stream to the first client and the second client; and the electronic device 1201 is further configured to receive the first video stream from the first server 1202.

In an exemplary embodiment, the electronic device 1201 is further configured to send, in response to a first switching instruction, the first switching instruction to the first server 1202, wherein the first switching instruction indicates that an operation authority is switched to a second target client, and the first server 1202 is further configured to respond to the operation instruction from the second target client based on the first switching instruction.

In an exemplary embodiment, the electronic device 1201 is further configured to display, in response to an operation request from the second target client, the operation request on the first client, and determine, in response to a confirmation instruction for the operation request, the confirmation instruction as the first switching instruction.

In an exemplary embodiment, the electronic device 1201 is further configured to switch the first screen displayed by the first client to a second screen corresponding to a second video stream in response to a second switching instruction, wherein the second switching instruction indicates screen switching, and the second video stream is captured by the electronic device 1201; the electronic device 1201 is further configured to send the second switching instruction and the second video stream to the first server 1202; and the first server 1202 is further configured to receive the switching instruction and the second video stream, send the second video stream to the second client, and stop sending the first video stream to the first client and the second client.

In an exemplary embodiment, the electronic device 1201 is further configured to display a second screen corresponding to the second video stream in the form of a floating window in the first screen in response to a third switching instruction, wherein the third switching instruction indicates that the first screen and the second screen are displayed simultaneously, and the second video stream is captured by a terminal.

In an exemplary embodiment, the electronic device 1201 is further configured to stop displaying the first screen in response to a second switching instruction, and switch the second screen from being displayed in the form of a floating window to being displayed in the form of a full screen, wherein the second switching instruction indicates screen switching.

In an exemplary embodiment, the electronic device 1201 is further configured to send the second video stream to the first server 1202, the second screen corresponding to the second video stream is configured to be displayed on the first screen in the form of a floating window, and the second video stream is captured by the electronic device 1201; and the first server 1202 is further configured to send the second video stream to the second client.

In the above system for displaying the screen, the first server 102 may push the video stream acquired from the second server 104 to the second client without requirement of simultaneously connecting two servers to the first thereby reducing the power consumption of the electronic device 1201 where the first client is disposed.

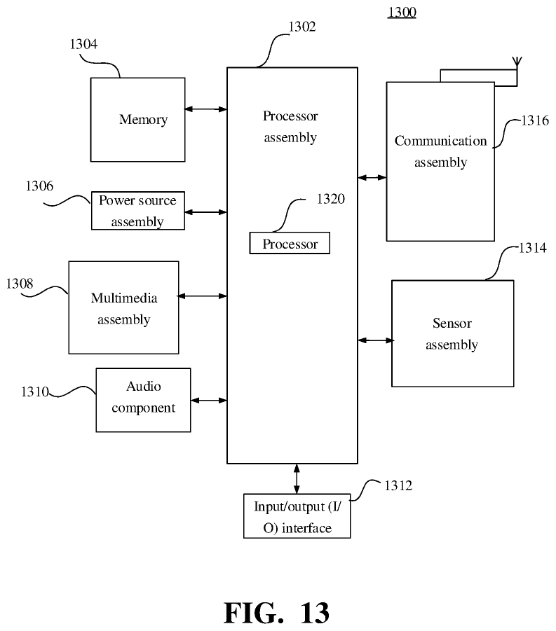

FIG. 13 is a block diagram of an electronic device 1300 for displaying a screen according to an exemplary embodiment of the present disclosure. The electronic device 1300 is configured to perform the method for displaying the screen as defined in the above embodiments. For example, the electronic device 1300 may be a mobile phone, a computer, a digital broadcast terminal, a message transceiver device, a game console, a tablet device, a medical device, a fitness device, a personal digital assistant, or the like.

As shown in FIG. 13, the electronic device 1300 may include one or more of the following assemblies: a processor assembly 1302, a memory 1304, a power source assembly 1306, a multimedia assembly 1308, an audio assembly 1310, an input/output (I/O) interface 1312, a sensor assembly t 1314 and a communication assembly 1316.

The processor assembly 1302 generally controls overall operations of the electronic device 1300, such as the operations associated with display, phone call, data communication, camera operation, and recording operation. The processor assembly 1302 may include one or more processors 1320 to execute instructions so as to accomplish all or part of the processes of the method described above. In addition, the processor assembly 1302 may include one or more modules to facilitate the interaction between the processor assembly 1302 and other assemblies. For example, the processor assembly 1302 may include a multimedia module to facilitate the interaction between the multimedia assembly 1308 and the processor assembly 1302.

The memory 1304 is configured to store various types of data so as to support the operation of the electronic device 1300. Examples of such data include instructions, contact data, phonebook data, messages, screens, videos, and the like for any application program or method operated on the electronic device 1300. The memory 1304 may be implemented by any type of volatile or non-volatile memory devices, or a combination thereof, such as a static random-access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The power source assembly 1306 provides power for various assemblies of the electronic device 1300. The power source assembly 1306 may include a power management system, one or more power sources, and other assemblies associated with the generation, management, and distribution of power for the electronic device 1300.

The multimedia assembly 1308 includes a screen providing an output interface between the electronic device 1300 and a user. In some embodiments, the screen may include a liquid crystal display (LCD) and a touch panel (TP). In response to the screen including the touch panel, the screen may be implemented as a touch screen to receive input signals from the user. The touch panel includes one or more touch sensors to sense touches, slips, and gestures on the touch panel. The touch sensors may not only sense a boundary of a touch or swipe action, but also detect a duration and a pressure associated with the touch or swipe action. In some embodiments, the multimedia assembly 1308 includes a front camera and/or a rear camera. The front camera and/or the rear camera may receive external multimedia data in the case that the electronic device 1300 is in an operation mode, such as a photographing mode or a video mode. Each the front camera and the rear camera may be a fixed optical lens system or have focal length and optical zooming capability.

The audio assembly 1310 is configured to output and/or input audio signals. For example, the audio assembly 1310 includes a microphone (MIC) configured to receive an external audio signal in the case that the electronic device 1300 is in an operation mode, such as a call mode, a recording mode, and a voice recognition mode. The received audio signal may be further stored in the memory 1304 or transmitted via the communication assembly 1316. In some embodiments, the audio assembly 1310 further includes a speaker configured to output an audio signal.

The I/O interface 1312 provides an interface between the processor assembly 1302 and a peripheral interface module. The above peripheral interface module may be a keyboard, a click wheel, buttons, or the like. These buttons may include, but are not limited to, a home button, a volume button, a start button, and a lock button.

The sensor assembly 1314 includes one or more sensors configured to provide status assessments of various aspects of the electronic device 1300. For example, the sensor assembly 1314 may detect an open/closed status of the electronic device 1300, relative positioning of assemblies, such as the assembly being a display and a keypad of the electronic device 1300, and the sensor assembly 1314 may further detect a change in position of the electronic device 1300 or an assembly of the electronic device 1300, a presence or absence of user contact with the electronic device 1300, an orientation or an acceleration/deceleration of the electronic device 1300, and a change in temperature of the electronic, device 1300. The sensor assembly 1314 may include a proximity sensor configured to detect the presence of nearby objects without any physical contact. The sensor assembly 1314 may further include an optical sensor, such as a complementary metal-oxide-semiconductor (CMOS) or charged coupled device (CCD) image sensor being applicable to imaging applications. In some embodiments, the sensor assembly 1314 may further include an accelerometer sensor, a gyroscope sensor, a magnetic sensor, a pressure sensor, or a temperature sensor.

The communication assembly 1316 is configured to facilitate wired or wireless communication between the electronic device 1300 and other devices. The electronic device 1300 may access a wireless network based on a communication standard, such as Wi-Fi, service provider network (such as 2G, 3G, 4G, or 5G), or a combination thereof. In an exemplary embodiment, the communication assembly 1316 receives a broadcast signal or broadcast-related information from an external broadcast management system via a broadcast. channel. In an exemplary embodiment, the communication assembly 1316 further includes a near field communication (NFC) module to facilitate short-range communication. For example, the NFC module may be implemented based on a radio frequency identification (RFID) technology, an infrared data association (IrDA) technology, an ultra-wideband (UWB) technology, a Bluetooth (BT) technology, and other technologies.

In an exemplary embodiment, the electronic device 1300 may be implemented by one or more application specific integrated circuits (ASIC), digital signal processors (DSP), digital signal processing devices (DSPD), programmable logic devices (PLD), field-programmable gate array (FPGA), controllers, microcontrollers, microprocessors, or other electronic elements to perform the above method.

In an exemplary embodiment, a storage medium including instructions, such as a memory 1304 including instructions, is further provided. For example, a non-transitory computer-readable storage medium may be a ROM, a random-access memory (RAM), compact disc read-only memory (CD-ROM), a magnetic tape, a floppy disk, an optical data storage device, or the like. The instructions in the storage medium, when executed by a processor of a server, cause the server to perform the method for displaying the screen as defined in the above embodiments.

An embodiment of the present disclosure further provides a computer program product. The computer program product includes one or more computer programs stored in a readable storage medium. The one or more computer programs, when loaded and run by at least one processor of a server, cause the server to perform the method for displaying the screen as defined in the above embodiments.

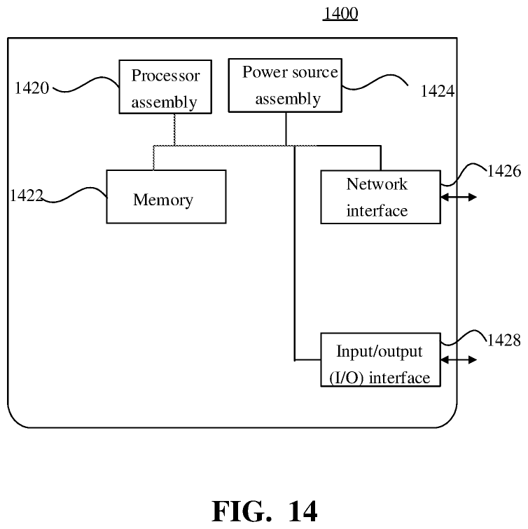

FIG. 14 is a block diagram of a device 1400 for displaying a screen according to an exemplary embodiment of the present disclosure. For example, the device 1400 may be a server. As shown in FIG. 14, the device 1400 includes a processor assembly 1420, which further includes one or more processors, and a memory resource represented by a memory 1422 for storing instructions executable by the processor assembly 1420, for example, an application program. The application program stored in the memory 1422 may include one or more modules, each of which corresponds to a set of instructions. In addition, the processor assembly 1420 is configured to execute instructions to perform the above method for displaying a screen.

The device 1400 may further include a power source assembly 1424 configured to perform power source management of the device 1400, a wired or wireless network interface 1426 configured to connect the device 1400 to a network, and an input/output (I/O) interface 1428. The device 1400 may operate an operating system stored in the memory 1422, such as Windows Server™, Mac OS X™, Unix™, Linux™, FreeBSD™, or the like.

An embodiment of the present disclosure further provides a server, including a processor and a memory configured to store an instruction executable by the processor, wherein the processor is configured to execute the instruction so as to perform the method for displaying the screen as defined in the above embodiments.

In an exemplary embodiment, a storage medium including instructions, such as a memory 1422 including one or more instructions, is further provided. The storage medium may be a non-transitory computer-readable storage medium, such as a ROM, a RAM, a CD-ROM, a magnetic tape, a floppy disk, and an optical data storage device. The one or more instructions in the storage medium, when loaded and executed by a processor of a server, cause the server to perform the method for displaying the screen as defined in the above embodiments.

An embodiment of the present disclosure further provides a computer program product. The computer program product includes one or more computer programs stored in a readable storage medium. The one or more computer programs, when loaded and run by at least one processor of a server, cause the server to perform the method for displaying the screen as defined in the above embodiments.

Each embodiment of the present disclosure can be executed individually or in combination with other embodiments, both of which shall be regarded as the scope of protection of the present disclosure.

What is claimed is:

1. A method for displaying a screen, executed by a first client, and comprising:
displaying a first screen corresponding to a first video stream, wherein the first screen is also displayed on a second client associated with the first client;
acquiring an operation instruction for the first screen, and sending the operation instruction to a first server, wherein the first server is configured to send the operation instruction to a second server, receive a first target video stream from the second server, and send the first target video stream to the first client and the second client, and the second server is configured to acquire the first target video stream in response to the operation instruction; and
receiving the first target video stream from the first server, and displaying a first target screen corresponding to the first target video stream on the first client, wherein the first target screen is also displayed on the second client.

2. The method according to claim 1, further comprising:
receiving the first video stream from the first server, wherein the first video stream is acquired by the first server from the second server, and the first server is further configured to send the first video stream to the second client.

3. The method according to claim 1, further comprising:
sending a first switching instruction to the first server, wherein the first switching instruction is configured to indicate that an operation authority is switched to a second target client associated with the first client, and the first server is configured to respond to an operation instruction from the second target client based on the first switching instruction.

4. The method according to claim 3, further comprising:
receiving an operation request from the second target client, and displaying the operation request on the first client; and
determining, in response to a confirmation instruction for the operation request, the confirmation instruction as the first switching instruction.

5. The method according to claim 1, further comprising:
switching the first screen displayed by the first client to a second screen corresponding to a second video stream in response to a second switching instruction, wherein the second switching instruction is configured to indicate screen switching, and the second video stream is captured by an electronic device where the first client is disposed; and
sending the second switching instruction and the second video stream to the first server, wherein the first server is configured to send the second video stream to the second client and stop sending the first video stream to the first client and the second client in response to the second switching instruction.

6. The method according to claim 1, further comprising:
displaying a second screen corresponding to a second video stream in a form of a floating window in the first screen in response to a third switching instruction, wherein the third switching instruction is configured to indicate that the first screen and the second screen are to be displayed simultaneously, and the second video stream is captured by an electronic device where the first client is disposed.

7. The method according to claim 6, further comprising:
stopping displaying the first screen and switching the second screen from being displayed in the form of a floating window to being displayed in a form of a full screen in response to a second switching instruction, wherein the second switching instruction is configured to indicate screen switching.

8. A method for displaying a screen, applicable to a first server, and comprising:
receiving a first video stream from a second server, and sending the first video stream to a first client and a second client, wherein the second client is associated with the first client;
receiving an operation instruction for a first screen from a first client, and sending the operation instruction to the second server, wherein the first screen is corresponding to the first video stream, and the second server is configured to acquire a first target video stream by updating the first video stream in response to the operation instruction; and
receiving the first target video stream from the second server, and sending the first target video stream to the first client and the second client.

9. The method according to claim 8, further comprising:
receiving a first switching instruction from the first client, wherein the first switching instruction is configured to indicate that an operation authority is switched to a second target client associated with the first client; and
responding to an operation instruction from the second target client based on the first switching instruction.

10. The method according to claim 9, further comprising:
stopping sending the operation instruction for the first screen to the first server in response to the first switching instruction.

11. The method according to claim 8, further comprising:
receiving a second switching instruction and a second video stream from the first client, wherein the second switching instruction is configured to indicate screen switching, and the second video stream is captured by an electronic device where the first client is disposed; and
sending the second video stream to the second client, and stopping sending the first video stream to the first client and the second client.

12. The method according to claim 8, further comprising:
acquiring a second video stream from the first client, wherein the second video stream is captured by an electronic device where the first client is disposed;
acquiring a second target video stream by adding the second video stream to the first video stream; and
sending the second target video stream to the first client and the second client, wherein in a second target screen corresponding to the second target video stream, a second screen corresponding to the second video stream is displayed in the first screen in a form of a floating window.

13. The method according to claim 8, further comprising:
sending a second video stream to the second client, and stopping sending the first video stream to the first client and the second client in response to a second switching instruction from the first client, wherein a second screen corresponding to the second video stream is switched from being displayed in a form of a floating window to being displayed in a form of a full screen.

14. An electronic device, comprising:
a processor; and
a memory configured to store one or more instructions executable by the processor;
wherein the processor, when loading and executing the one or more instructions, is caused to perform:
displaying a first screen corresponding to a first video stream on a first client, wherein the first screen is also displayed on a second client associated with the first client;
acquiring an operation instruction for the first screen, and sending the operation instruction to a first server, wherein the first server is configured to send the operation instruction to a second server, receive a first target video stream from the second server, and send the first target video stream to the first client and the second client, and the second server is configured to acquire the first target video stream in response to the operation instruction; and
receiving the first target video stream from the first server, and displaying a first target screen corresponding to the first target video stream on the first client, wherein the first target screen is also displayed on the second client.

15. The electronic device according to claim 14, wherein the processor, when loading and executing the one or more instructions, is further caused to perform:
receiving the first video stream from the first server, wherein the first video stream is acquired by the first server from the second server, and the first server is further configured to send the first video stream to the second client.

16. The electronic device according to claim 14, wherein the processor, when loading and executing the one or more instructions, is further caused to perform:
sending a first switching instruction to the first server, wherein the first switching instruction is configured to indicate that an operation authority is switched to a second target client associated with the first client, and the first server is configured to respond to an operation instruction from the second target client based on the first switching instruction.

17. The electronic device according to claim 16, wherein the processor, when loading and executing the one or more instructions, is further caused to perform:
receiving an operation request from the second target client, and displaying the operation request; and
determining, in response to a confirmation instruction for the operation request, the confirmation instruction as the first switching instruction.

18. The electronic device according to claim 14, the processor, when loading and executing the one or more instructions, is further caused to perform:
switching the first screen displayed by the first client to a second screen corresponding to a second video stream in response to a second switching instruction, wherein the second switching instruction is configured to indicate screen switching, and the second video stream is captured by an electronic device where the first client is disposed; and
sending the second switching instruction and the second video stream to the first server, wherein the first server is configured to send the second video stream to the second client and stop sending the first video stream to the first client and the second client in response to the second switching instruction.

19. The electronic device according to claim 14, wherein the processor, when loading and executing the one or more instructions, is further caused to perform:
displaying a second screen corresponding to a second video stream in a form of a floating window in the first screen in response to a third switching instruction, wherein the third switching instruction is configured to indicate that the first screen and the second screen are to be displayed simultaneously, and the second video stream is captured by an electronic device where the first client is disposed.

20. The electronic device according to claim 19, wherein the processor, when loading and executing the one or more instructions, is further caused to perform:
stopping displaying the first screen and switching the second screen from being displayed in the form of a floating window to being displayed in a form of a full screen in response to a second switching instruction, wherein the second switching instruction is configured to indicate screen switching.
